(19) United States
(12) Patent Application Publication
(10) Pub. No.: US 2014/0162568 A1
(43) Pub. Date: Jun. 12, 2014

(54) ON-CHIP CALIBRATION AND BUILT-IN-SELF-TEST FOR SOC MILLIMETER-WAVE INTEGRATED DIGITAL RADIO AND MODEM

(71) Applicant: ANAYAS360.COM, LLC, Sunnyvale, CA (US)

(72) Inventor: Joy Laskar, Los Altos, CA (US)

(73) Assignee: ANAYAS360.COM, LLC, Sunnyvale, CA (US)

(21) Appl. No.: 14/099,593

(22) Filed: Dec. 6, 2013

Related U.S. Application Data
(60) Provisional application No. 61/734,907, filed on Dec. 7, 2012.
(60) Provisional application No. 61/734,882, filed on Dec. 7, 2012.
(60) Provisional application No. 61/734,878, filed on Dec. 7, 2012.

(51) Int. Cl. H04B 17/00

(52) U.S. Cl. CPC H04B 17/00
USPC 455/67.14

(57) ABSTRACT

A method for calibrating a wireless data transceiver package can include transmitting, by a testing device, a first control sequence to a wireless data transceiver. The transceiver can include a receiver and a transmitter. The first control sequence can include instructions for setting input parameters of the transmitter. The method can further include transmitting, by the testing device, a second control sequence to the transceiver that can include instructions for setting input parameters of the receiver. The method can further include receiving, from the transceiver, a third control sequence that can include output parameters of the transceiver. The method can further include determining a coupling between the receiver and the transmitter based on the output parameters. The method can further include determining a bit error rate of the transceiver based on the coupling. The method can further include calibrating a second transceiver based on the bit error rate.

### CROSS-REFERENCE TO RELATED APPLICATIONS

This application claims priority to U.S. Provisional Patent Application No. 61/734,907, entitled “ADAPTIVE TUNING VOLTAGE BUFFER FOR MILLIMETER-WAVE MULTI-CHANNEL FREQUENCY SYNTHESIZER EXAMPLE EMBODIMENTS” and filed on Dec. 7, 2012, to U.S. Provisional Patent Application No. 61/734,882, entitled “HIGHLY INTEGRATED MILLIMETER-WAVE SOC LAYOUT TECHNIQUES FOR IMPROVED PERFORMANCE AND MODELING ACCURACY” and filed on Dec. 7, 2012, and to U.S. Provisional Patent Application No. 61/734,878, entitled “ON-CHIP CALIBRATION AND BUILT-IN-SELF-TEST FOR SOC MILLIMETER-WAVE INTEGRATED DIGITAL RADIO AND MODEM” and filed on Dec. 7, 2012, the entire contents of which disclosures are herewith incorporated by reference.

This application is related to U.S. patent application Ser. No. ______, entitled “ADAPTIVE TUNING VOLTAGE BUFFER FOR MILLIMETER-WAVE MULTI-CHANNEL FREQUENCY SYNTHESIZER EXAMPLE EMBODIMENTS” and filed on ______ [Attorney Docket No. ANAYA.004A], and U.S. patent application Ser. No. ______, entitled “HIGHLY INTEGRATED MILLIMETER-WAVE SOC LAYOUT TECHNIQUES FOR IMPROVED PERFORMANCE AND MODELING ACCURACY” and filed on ______ [Attorney Docket No. ANAYA.005A], the entire contents of which disclosures are herewith incorporated by reference.

### BACKGROUND

Consumer electronics may be equipped with communication devices that permit the wireless transfer of data. For example, consumer electronics can include Wi-Fi chips to communicate via the IEEE 802.11 standard, Bluetooth chips to communicate via the Bluetooth communication protocols, or other such chips. As wireless communication technology has improved, more and more data is being transferred using wireless means.

Traditionally, large data files (e.g., audio files, video files, uncompressed image files, such as in the RAW format, etc.) have been transferred using conventional wired protocols even as wireless communication technology has improved due to the power consumption and delay associated with transferring such large data files. However, the ability to transfer large data files wirelessly from one electronic device to another may benefit both users and the manufacturers of electronic devices that manage these large data files if power consumption and delay can be reduced. Users may see a reduction in incompatibility issues between devices and less clutter. As for manufacturers, the connection ports and cables often dictate the shape and size of the electronic device. In fact, because cables and connectors should be large enough so that they can be handled by adult humans, electronic devices are often designed to be larger than they otherwise need to be. Thus, the ability to transfer large data files wirelessly could significantly reduce the form factor of electronic devices that manage large data files.

Transceivers receive and transmit signals, typically wirelessly via an antenna. Before being deployed into the field, a transceiver may be tested during various stages of production. Such testing can be costly, especially as high data rate transceivers are developed.

### SUMMARY

The development of fully-integrated transceivers for millimeter wave frequencies (and other high frequencies) may usher in a new wave of applications that were inconceivable in the past. However, it can be expensive to test various aspects of the millimeter wave frequency transceivers. To make such applications attractive for high volume consumer applications, the cost of testing millimeter wave frequency transceivers in different stages of production may have to be lowered.

Accordingly, embodiments are described herein of a digitally controlled radio and modem system on chip (SOC) self-test methodology in a test-socket environment that can reduce the cost of testing. In addition, different programmable features of the digitally controlled radio can be calibrated (e.g., automatically) on-chip and/or in a standard test socket. The packaging approach used and described herein can be markedly different from currently available technology, which tends to be based on expensive and bulky metal housings, high performance ceramic substrates, and/or low-volume manual multi-chip hybrid assemblies. Embodiments of the methodologies described herein can lower the number of design cycles used in integrated product development and/or can reduce testing costs.

One aspect of the disclosure provides a method for calibrating a wireless data transceiver package comprising transmitting, by a testing device, a first control sequence to a wireless data transceiver. The wireless data transceiver may comprise a receiver and a transmitter. The first control sequence may comprise instructions for setting input parameters of the transmitter. The method further comprises transmitting, by the testing device, a second control sequence to the wireless data transceiver. The second control sequence may comprise instructions for setting input parameters of the receiver. The method further comprises receiving, from the wireless data transceiver by the testing device, a third control sequence. The third control sequence may comprise a first set of output parameters of the wireless data transceiver. The method further comprises determining, by the testing device, a first coupling between the receiver and the transmitter based on the first set of output parameters. The method further comprises determining a bit error rate of the wireless data transceiver based on the determined first coupling. The method further comprises calibrating a second wireless data transceiver based on the determined bit error rate.

Another aspect of the disclosure provides a method for self-calibrating a wireless data transceiver package comprising transmitting a first set of instructions to a wireless data transceiver. The wireless data transceiver may comprise a receiver and a transmitter. The first set of instructions may comprise instructions for setting input parameters of the transmitter. The method further comprises detecting output parameters of the transmitter after the transmitter transmits a first signal based on the first set of instructions. The method further comprises transmitting a second set of instructions to the wireless data transceiver based on the detected output parameters. The second set of instructions may comprise instructions for revising the input parameters of the transmitter. The method further comprises detecting output parameters of the receiver after the transmitter transmits a second signal based on the second set of instructions. The method further comprises determining a bit error rate of the wireless data transceiver based on the detected output parameters of the receiver. The method further comprises identifying a deviation of the determined bit error rate from a reference bit error rate. The method further comprises adjusting input parameters of the receiver responsive to the identified deviation of the determined bit error rate from the reference bit error rate.

Another aspect of the disclosure provides a wireless data transceiver testing system comprising a reflector configured to redirect wireless transmissions. The wireless data transceiver testing system further comprises a wireless data transceiver package comprising a wireless transmitter configured to generate a signal. The wireless data transceiver package may further comprise a transmit antenna coupled to the wireless transmitter. The transmit antenna may be configured to transmit the signal generated by the wireless transmitter. The wireless data transceiver package may further comprise a receive antenna configured to receive the signal after the signal is redirected by the reflector. The wireless data transceiver package may further comprise a wireless receiver configured to process the signal. The wireless data transceiver testing system further comprises a testing device configured to be coupled to the wireless data transceiver package. The testing device may be configured to instruct the wireless transmitter to generate the signal, to receive measurements from the wireless data transceiver package after the signal is processed by the receiver, and to use the measurements to calibrate the wireless data transceiver package.

Certain aspects, advantages and novel features of the inventions are described herein. It is to be understood that not necessarily all such advantages may be achieved in accordance with any particular embodiment of the inventions disclosed herein. Thus, the inventions disclosed herein may be embodied or carried out in a manner that achieves or selects one advantage or group of advantages as taught herein without necessarily achieving other advantages as may be taught or suggested herein.

### BRIEF DESCRIPTION OF THE DRAWINGS

Throughout the drawings, reference numbers can be re-used to indicate correspondence between referenced elements. The drawings are provided to illustrate embodiments of the inventions described herein and not to limit the scope thereof.

FIG. 1 illustrates a block diagram of an example MMW transceiver.

FIG. 2A illustrates an example loop-back self-test environment for a MMW package.

FIG. 2B illustrates an example on-wafer probe card-based testing scenario.

FIG. 2C illustrates an example low-cost high-volume test socket-based package assembly testing scenario.

FIG. 2D illustrates an example of bit error rate versus input power and data rate.

FIG. 3 illustrates a flowchart of an example calibration procedure for a known transceiver package.

FIG. 4 illustrates a flowchart of a method for self-calibrating an unknown transceiver package.

FIG. 5 illustrates a flowchart of a method for self-calibrating an ADC in the receiver chain.

FIG. 6 illustrates an example docking system.

### DETAILED DESCRIPTION

### Introduction

Transceivers that communicate in the millimeter wave (MMW) frequencies may be able to handle the wireless transfer of large data files at high data rates and low power consumption. Accordingly, described herein are transceivers and components thereof that can achieve the goals described above. While aspects of the disclosure are described herein with respect to MMW frequencies, this is not meant to be limiting. As an example, MMW frequencies may be centered at 60 GHz, although higher and lower frequencies may also be considered MMW frequencies. However, the features described herein apply to any device that communicates at high frequencies (e.g., 2.4 GHz, 5 GHz, 20-120 GHz, higher frequencies than 120 GHz, frequencies lower than 20 GHz, and the like).

The development of fully integrated MMW transceivers (e.g., fully integrated CMOS MMW transceivers) for MMW frequencies may usher in a new wave of MMW applications that were inconceivable in the past. However, it can be expensive to test various aspects of the MMW transceivers. Typically, the MMW transceivers comprise various discrete components that are each tested individually. As more components are included in the MMW transceivers, the testing costs may begin to rise. For example, costs can approach $1 million or more. To make such MMW applications attractive for high volume consumer applications, the cost of testing MMW transceivers in different stages of production may have to be lowered.

Accordingly, embodiments are described herein of a digitally controlled radio and modem system on chip (SOC) self-test methodology in a low-cost test-socket environment that can reduce the cost of testing. For example, the digitally controlled radio and modem SOC may be a CMOS digitally controlled radio and modem SOC. In addition, different programmable features of the digitally controlled radio can be calibrated (e.g., automatically) on-chip and/or in a standard test socket. The packaging approach used and described herein can be markedly different from currently available MMW technology, which is based on expensive and bulky metal housing, high performance ceramic substrate, and/or low-volume manual multi-chip hybrid assembly. The example methodologies described herein can lower the number of design cycles used in integrated MMW product development and/or can reduce testing costs (e.g., by an order of magnitude, such as from $50 to $5 or less) to make mass production of low-cost MMW solutions viable.

A typical small form factor integrated-antenna package prototype that includes an integrated CMOS MMW bits-in-bits-out integrated modem radio chipset may not be suitable for low-cost high-volume production. In addition, a traditional multi-equipment, time and cost intensive testing methodology may not viable for low-cost mass production of such portable MMW transceiver systems. In certain embodiments, a new self-test procedure is provided that may provide a fast and low-cost characterization with additional features (e.g., on-chip calibration, gradation of products, etc.).

Generally, self-test procedures for transceivers (e.g., even those that operate at low radio frequencies (RF), such as 3 KHz to 100 MHz) include additional on-chip/on-board sensors and test circuits that may not be suitable for high volume MMW applications. In certain embodiments, the example methodology described herein does not include or require any additional MMW in the chip or package assembly, thereby reducing overall cost and die area of the MMW transceiver.

For ease of illustration, various features are described herein with respect to MMW transceivers. However, some or all of these features may also be implemented in other transceivers, receivers, or transmitters designed for wavelengths other than millimeter waves.

Further, the systems and methods described herein can be implemented in any of a variety of electronic devices, including, for example, cell phones, smart phones, personal digital assistants (PDAs), tablets, mini-tablets, laptops, desktops, televisions, digital video recorders (DVRs), set-top boxes, media servers, audio/visual (NV) receivers, video game systems, high-definition disc players (such as Blu-ray® players), computer peripherals (such as mice, keyboards, scanners, printers, copiers, and displays), universal serial bus (USB) keys, cameras, routers, switches, other network hardware, radios, stereo systems, loudspeakers, sound bars, appliances, vehicles, digital picture frames, and medical devices, to name a few.

For purposes of summarizing this disclosure, certain aspects, advantages and novel features of several embodiments have been described herein. It is to be understood that not necessarily all such advantages can be achieved in accordance with any particular embodiment of the embodiments disclosed herein. Thus, the embodiments disclosed herein can be embodied or carried out in a manner that achieves one advantage or group of advantages as taught herein without necessarily achieving other advantages as taught or suggested herein.

### MMW Transceiver Overview

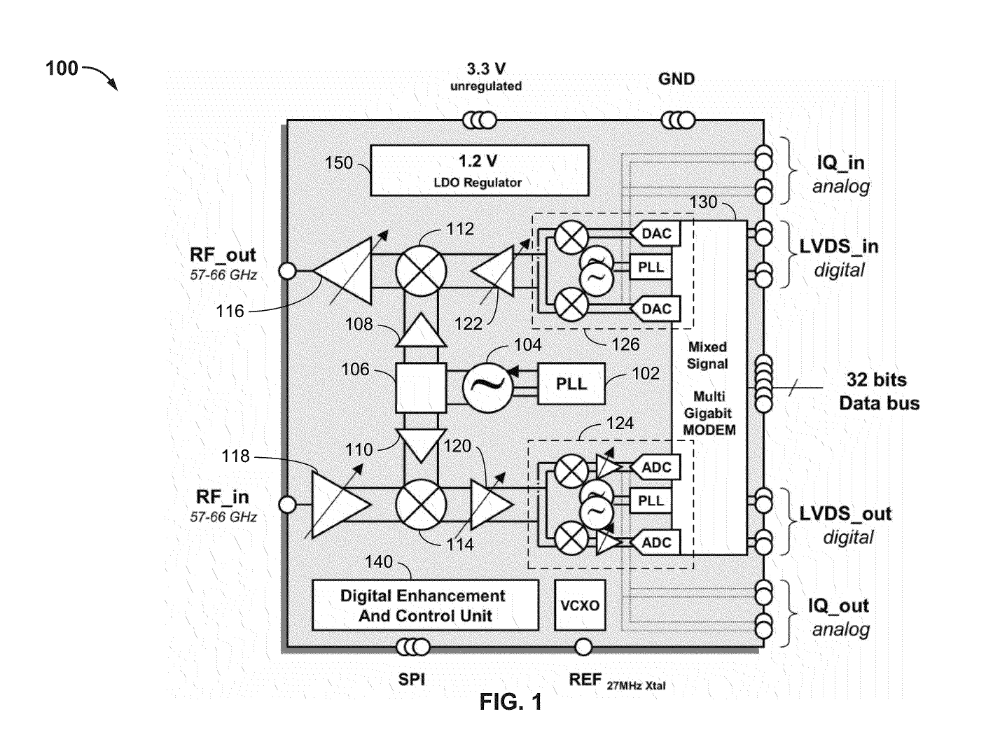

FIG. 1 illustrates a block diagram of an example MMW transceiver 100. As described above, the MMW transceiver 100 includes various input ports, output ports, analog components, and/or digital components. For example, as illustrated in FIG. 1, the MMW transceiver 100 includes an RF_in port and an RF_out port. The RF_in port is configured to receive MMW signals transmitted by another device within a set frequency range (e.g., a MMW frequency range, such as 57-66 GHz, etc.). The RF_out port is configured to transmit MMW signals to one or more devices within a set frequency range (e.g., a MMW frequency range, such as 57-66 GHz, etc.).

The MMW transceiver 100 further includes components to process signals received via the RF_in port and/or generate signals to be transmitted via the RF_out port. For example, the MMW transceiver 100 includes PLL 102, LO 104, signal distribution block (e.g., splitter) 106, gain blocks 108 and 110, up-conversion frequency mixer 112, down-conversion frequency mixer 114, amplifiers 116, 118, 120, and 122, baseband (BB) blocks 124 and 126, mixed-signal modem 130, digital enhancement and control unit 140, and voltage regulator 150. In an embodiment, PLL 102 and LO 104 generate a LO signal that is passed to the signal distribution block 106 and the gain blocks 108 and 110. The signal distribution block 106 can be configured to distribute the LO signal to multiple components. Gain blocks 108 and 110 amplify the LO signal so that the LO signal can properly drive the frequency mixers 112 and/or 114. However, in other embodiments, as described herein, one of more of the gain blocks 108 and/or 110 can be removed.

In some embodiments, the MMW signal received via the RF_in port is passed to amplifier 118. As an example, amplifier 118 may be a low noise amplifier (LNA). The amplifier 118 can adjust the amplitude of the received MMW signal and pass it to the down-conversion frequency mixer 114. The down-conversion frequency mixer 114 can down-convert the MMW signal from a MMW frequency to an intermediate frequency (IF) or a BB frequency using the LO signal. The down-converted signal then passes through amplifier 114 before being processed by the BB blocks 124.

Likewise, the MMW signal transmitted via the RF_out port is generated based on a signal generated by the BB blocks 126 that passes through amplifier 122 and the LO signal. In an embodiment, the signal generated by the BB blocks 126 is a BB or IF signal. The up-conversion frequency mixer 112 upconverts the BB or IF signal to a MMW signal using the LO signal. The MMW signal may pass through amplifier 116 before transmission occurs.

In some embodiments, the mixed-signal modem 130 is a digital component that transmits data to and receives data from other components of an electronic device (e.g., memory, a processor, etc.). For example, the data can be communicated via a 32-bit data bus. Data received by the mixed-signal modem 130 via the data bus can be transferred to the BB blocks 126. Likewise, data received by the mixed-signal modem 130 from the BB blocks 124 can be transferred to other components of the electronic device via the data bus.

Digital enhancement and control unit 140 provides digital means for controlling the various analog and/or digital components of the MMW transceiver 100. For example, digital enhancement and control unit 140 can adjust the characteristic or performance of the amplifier 118, the down-conversion frequency mixer 114, and so on.

In an embodiment, voltage regulator 150 generates an approximately constant voltage (e.g., 1.2V) that is supplied to one or more components of the MMW transceiver 100. The voltage regulator 150 may generate the approximately constant voltage based on an unregulated voltage (e.g., 3.3V) received via a port of the MMW transceiver 100.

Example on-Chip Calibration and Built-in Self-Test for MMW Transceiver Systems

In an embodiment, a loop-back test may involve a testing device that provides digital controls or commands to a transceiver and receives digital outputs in return. The digital controls may instruct a transceiver to transmit a signal. Thus, the transceiver may take a digital input and produce an analog output. An object may be placed in the signal path such that the transmitted signal is reflected off of the object and received by the receiver of the transceiver. The transceiver may process the reflected signal and provide measurements back to the testing device. Thus, the transceiver may take an analog input and produce a digital output. Accordingly, the testing device sends digital controls and receives digital outputs, yet the digital outputs may include analog and/or digital measurements.

The loop-back test described herein may provide benefits. For example, generally the components of a transceiver are discrete elements, not a fully integrated chip. Thus, both digital and analog components may be tested separately. Measuring a high frequency signal, in particular, can be costly because of the cables required to test such high frequencies. However, in the loop-back test described herein, a fully integrated chip is tested. Because a transmitted signal is reflected back to the chip and the chip is fully integrated, the high frequency signals may not have to be monitored separately, thereby reducing testing costs. Likewise, the reliability of the cables used to test high frequencies may be limited. Thus, testing and calibration procedures may be more accurate using the loop-back test described herein.

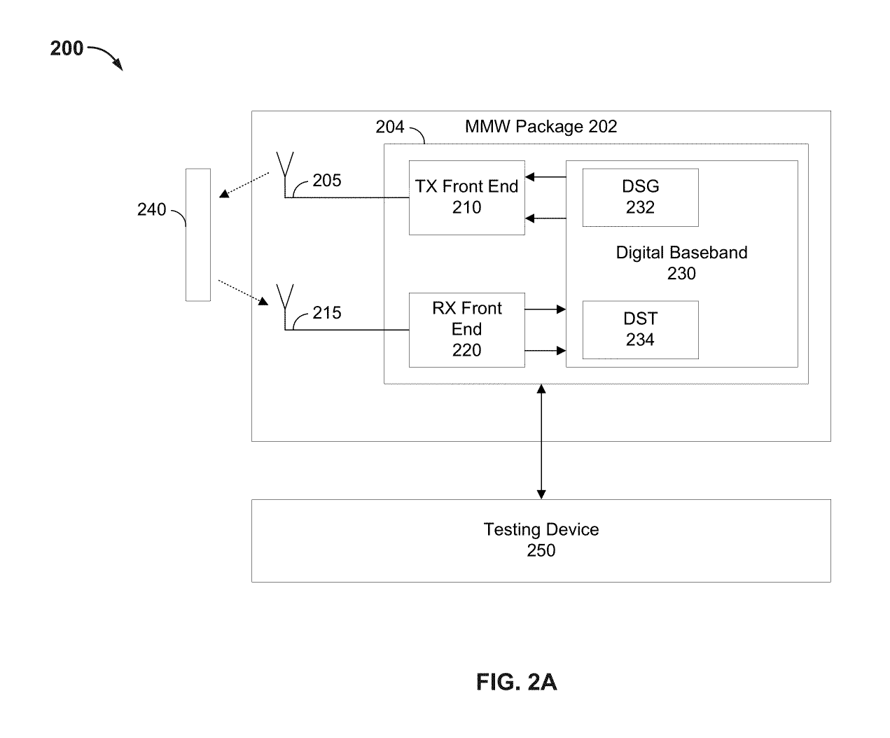

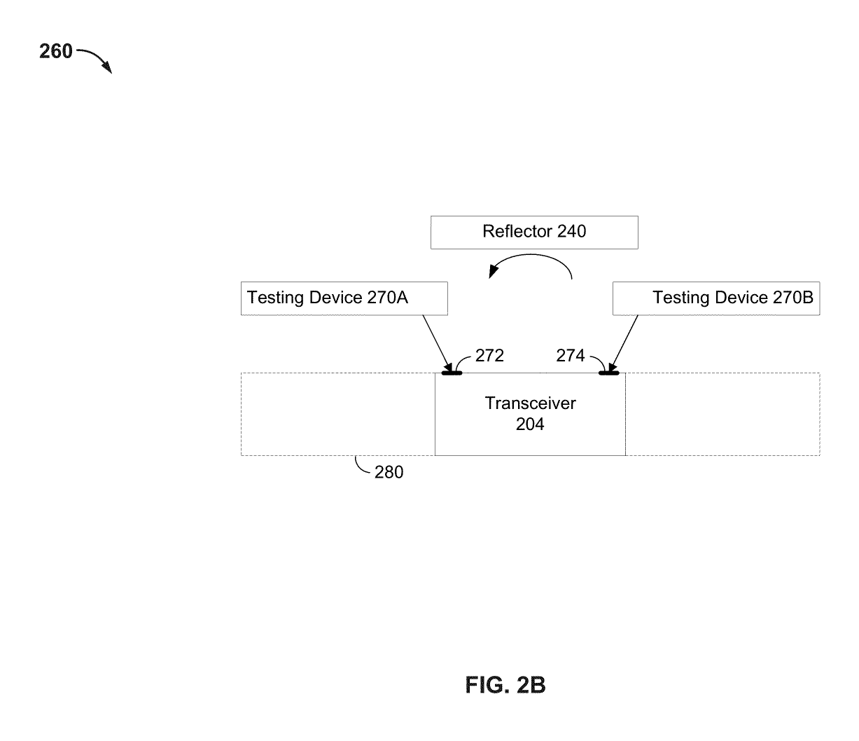

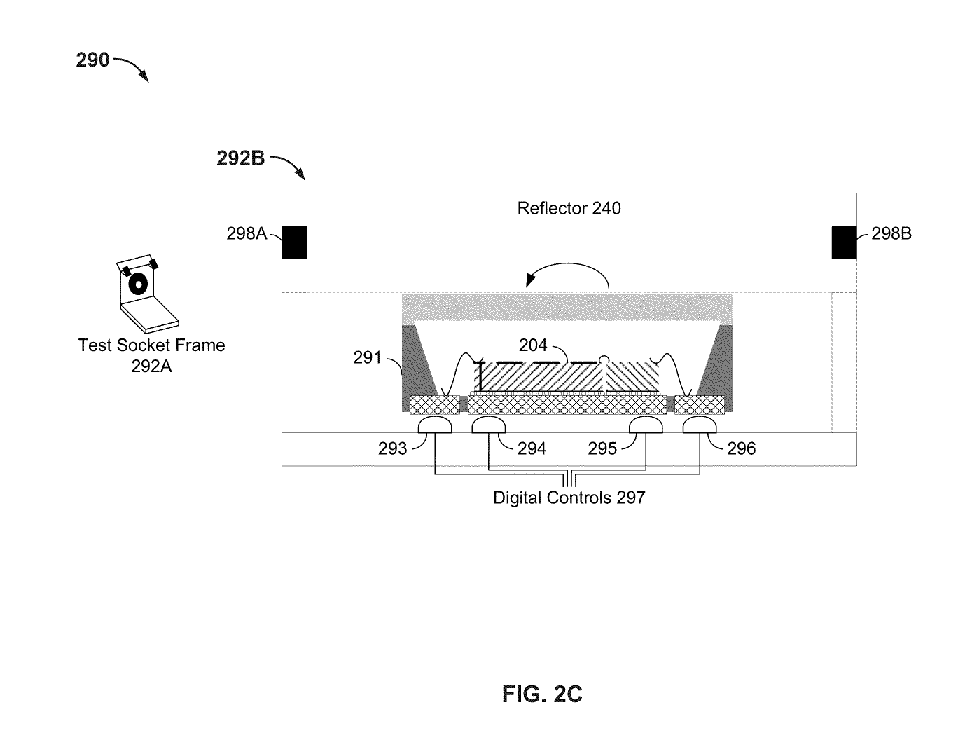

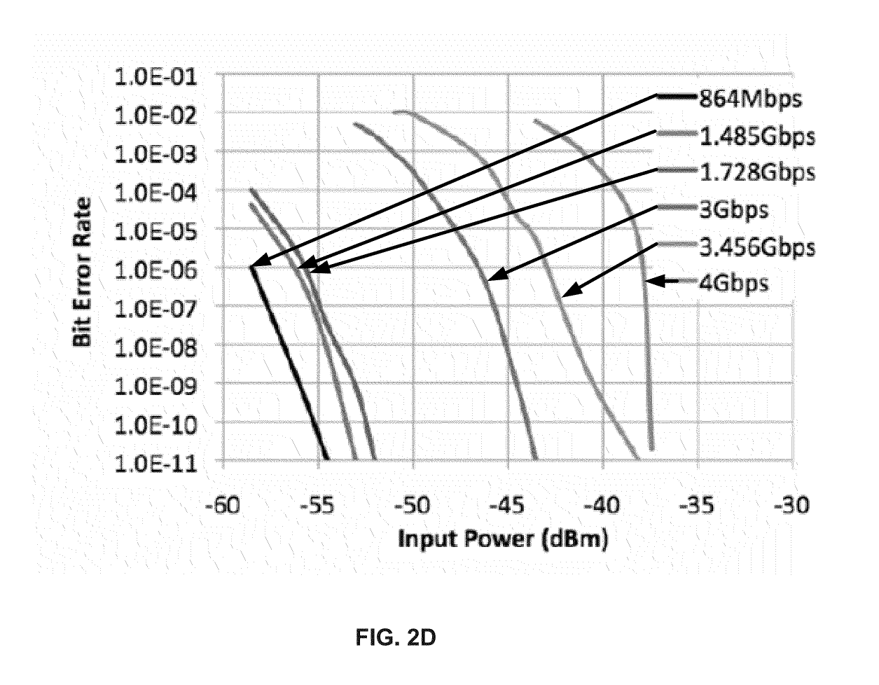

FIG. 2A illustrates an example loop-back self-test environment 200 for a MMW package 202. The loop-back self-test may not use any additional MMW circuits in the MMW radio SOC. Thus, the size of the chip and costs may be reduced or minimized while little or no degradation of MMW performance may be observed.

As illustrated in FIG. 2A, the MMW package 202 includes a transceiver 204 and antennas 205 and 215. In an embodiment, the transceiver 204 is a single-chip MMW CMOS transceiver. The transceiver 204 may further be a MMW bits-in-bits-out integrated modem digital radio. The antennas 205 and/or 15 may be embedded antennas (e.g., embedded within the MMW package 202). The antennas 205 and 215 may also be coupled with each other (e.g., via field coupling).

The transceiver 204 may include a transmitter front end 210, a receiver front end 220, and a digital baseband (BB) circuit 230. In an embodiment, the transmitter front end 210 and the receiver front end 220 are coupled to each other. For example, a signal pad of the transmitter front end 210 and a signal pad of the receiver front end 220 may be coupled on-chip via a substrate (e.g., a silicon substrate). As another example, the antenna 205 of the transmitter front end 210 and the antenna 215 of the receiver front end 220 can include field coupling in a package assembly in the absence of a reflector (e.g., reflector 240 described below). As another example, the antenna 205 of the transmitter front end 210 and the antenna 215 of the receiver front end 220 can include field coupling in a package assembly in the presence of the reflector. As another example, a transmitter front end 210 output pad (which acts like an antenna) and a receiver front end 220 input pad (which acts like an antenna) can include field coupling in the presence of the reflector. As another example, a transmitter front end 210 output pad (which acts like an antenna) and a receiver front end 220 input pad (which acts like an antenna) can include field coupling in the absence of the reflector. The transmitter front end 210 may be configured to generate a signal that is transmitted via the antenna 205. The receiver front end 220 may be configured to process a signal that is received via the antenna 215. The digital BB circuit 230 may include a digital sequence generator (DSG) 232 and a digital sequence tester (DST) 234. The transceiver 204 may be coupled to a testing device 250.

In an embodiment, the testing device 250 includes a processor, a DC regular, an oscillator (e.g., a crystal oscillator, a crystal, etc.), and/or other components. The testing device 250 may be a probe card, a test socket, and/or any such similar component.

In an embodiment of the testing scenarios 260 and 290, described below, the transceiver 204 (e.g., the MMW SOC) includes the DSG 232 in a transmitter BB and the DST 234 (e.g., a digital known sequence checker circuit) in the receiver BB. This overhead may be negligible in terms of cost and/or area. Low frequency BB signals may be coupled to a testing device, such as the testing device 250, and low cost BB signal analyzers can be used to analyze the low frequency BB signals.

The environment 200 may include a reflector 240. The reflector 240 may be a metal reflector. The reflector 240 may be used to reflect a signal transmitted by the transmit front end 210 via the antenna 205 to the antenna 215. The receive front end 220 may process the reflected signal and the testing device 250 may gather measurements related to the transmission, reception, and operation of the transceiver 204. In some embodiments, the testing device 250 receives digital values that represent analog and/or digital measurements.

FIG. 2B illustrates an example on-wafer probe card-based testing scenario 260. As illustrated in FIG. 2B, the testing scenario 260 includes the transceiver 204, the reflector 240, a testing device 270A, a testing device 270B, contacts 272 and 274, and a wafer 280. The testing devices 270A and 270B may be probe cards and include digital controls. In some embodiments, the wafer 280 is a CMOS wafer.

In an embodiment, the testing scenario 260 is performed on-wafer. For example, the transceiver 204 may be embedded within wafer 280 along with other transceivers. The transceiver 204 may transmit a signal and receive the same signal after the signal reflects off the reflector 240. The transmit and receive portions of the transceiver 204 may be coupled on-chip (e.g., on the transceiver 204) in a manner as described above with respect to the transmitter front end 210 and the receiver front end 220. For example, the antennas of the transceiver 204 that are used to transmit and receive the signal may be coupled through the reflector 240 and/or via pad radiation. The testing devices 270A and 270B may be used to probe the transceiver 204 while it is embedded within the wafer 280 and/or transmitting and receiving a signal. The testing device 270A may probe the transceiver 204 at the contact 272 and the testing device 270B may probe the transceiver 204 at the contact 274.

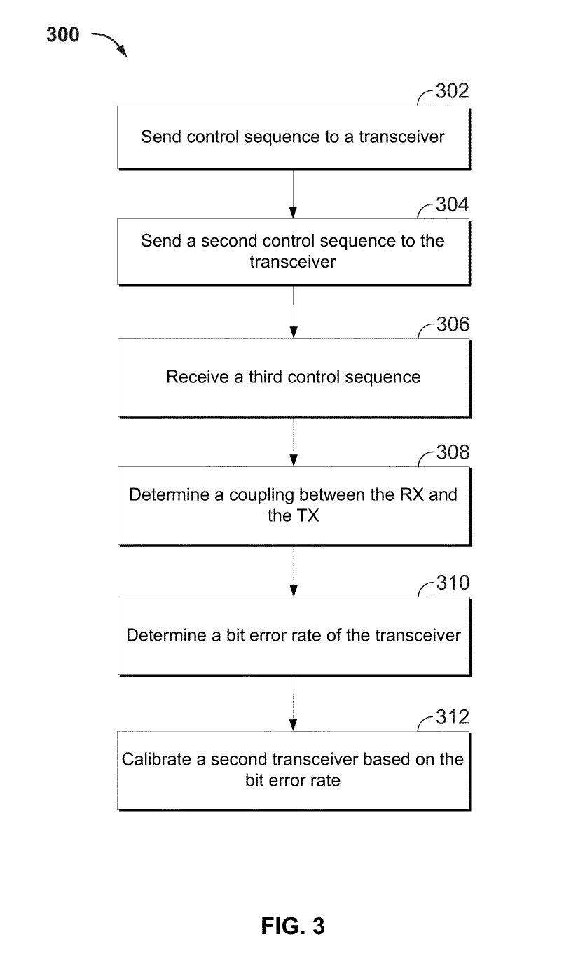

Before the testing scenario 260 is performed, calibration may be performed. Separate calibration steps are used in certain embodiments to validate different test setups using the testing devices 270A and/or 270B or the package assembly (e.g., the MMW package 202). The test setups may be validated with or without the use of the reflector 240. The type of antenna used in the package assembly can be an additional parameter used as an input during the calibration. An example calibration procedure is described below with respect to FIG. 3.

FIG. 2C illustrates an example low-cost high-volume test socket-based package assembly testing scenario 290. In an embodiment, the testing scenario 290 includes the testing of a test socket frame 292. Test socket frame 292A represents a diagram of the test socket frame 292 in an open configuration. Test socket frame 292B represents a cross-section diagram of the test socket in a closed configuration. As illustrated in FIG. 2C, the testing scenario 290 includes the transceiver 204, the reflector 240, a package 291, testing bumps 293-296, and blocks 298A-B. Blocks 298A-B may provide proper alignment and spacing for the reflector 240 when the test socket frame 292 is closed.

In an embodiment, the package 291 is any type of package that encases or encloses the transceiver 204. For example, the package 291 can be a quad flat no leads (QFN) package, a quad flat package (QFP), a chip scale package (CSP), a ball grid array (BGA) package, and/or the like.

In an embodiment, the testing scenario 290 includes providing digital controls to the transceiver 204. For example, digital controls 297 may be provided to the transceiver 204 via one or more of the testing bumps 293-296. Based on the received digital controls 297, the transceiver 204 may transmit a signal that reflects off the reflector 240 and is received by the transceiver 204. As described above, the transmit and the receive antennas of the transceiver 204 may be directly coupled. In addition, the transmit and the receive antennas of the transceiver 204 may include coupling via the reflector 240. The test socket frame 292 may serve as an interface for a testing device, such as the testing device 250, to gather measurements related to the transmission, reception and operation of the transceiver 204. In some embodiments, the testing device receives digital values that represent analog and/or digital measurements.

In an embodiment, calibration is performed before, during, or after the testing scenario 290 is performed. The calibration may be similar to the calibration described above with respect to FIG. 2B. An example calibration procedure is described below with respect to FIG. 3.

### Calibration Flowcharts

In an embodiment, calibration procedures are provided for different MMW SOC self-test environments to determine the signal coupling between the transmitter output and the receiver input of a transceiver. For example, a calibration procedure may include an on-wafer loop-back self-test using a testing device (e.g., a probe card). The transmitter and the receiver signal pads may be coupled via the substrate in the MMW integrated digital radio chip. The transmitter output pad (acting as an antenna) and the receiver input pad (acting as an antenna) may include field coupling in the presence of a reflector. As another example, a calibration procedure may include a final product assembly loop-back self-test using a testing device (e.g., a test socket). The transmitter and the receiver signal pads may be coupled via the substrate in the MMW integrated digital radio chip. The transmitter antenna and the receiver antenna may include field coupling in the package assembly in the absence of any reflectors. As another example, a calibration procedure may include a final product assembly loop-back self-test using a testing device (e.g., a test socket). The transmitter and the receiver signal pads may be coupled via the substrate in the MMW integrated digital radio chip. The transmitter antenna and the receiver antenna may include field coupling in the package assembly in the presence of one or more reflectors.

As described herein, a transceiver, such as the MMW transceiver 100, may include input parameters and output parameters. Input parameters may include parameters of the transceiver that can be controlled by the testing device. For example, input parameters may include the supply voltage, one or more bias voltages, a transmitter gain, a receiver gain, transmitter output power, and/or the like. Output parameters may include parameters of the transceiver that are generated as a result of an operation of the transceiver. For example, output parameters may include a transmitter IF center frequency, a transmitter IF power level, a transmitter IF amplifier bandwidth, a receiver IF center frequency, a receiver IF power level, a receiver IF amplifier bandwidth, a receiver BB power level, a receiver BB amplifier bandwidth, a frequency generated by a frequency synthesizer, a frequency synthesizer locked tuning voltage, a transmitter frequency synthesizer PLL locked voltage, a transmitter bandwidth for some or each data rate, a receiver bandwidth for some or each data rate, transmitter temperature, receiver temperature, an automatic gain control (AGC) reference voltage, an analog-to-digital converter (ADC) noise value, an integral non-linearity (INL) of an ADC, a differential non-linearity (DNL) of an ADC, current draw, receiver signal strength indicator (RSSI), a frequency offset of a transmitter IF quadrature voltage-controlled oscillator (QVCO), a frequency offset of a receiver IF QVCO, frequencies produced by components of the transceiver not otherwise listed herein, and/or the like.

In some embodiments, the same procedure used for performing a loop-back test (e.g., for MMW bits-in bits-out devices) may be used for the self-calibration of different output parameters at little to no extra testing overhead. Thus, because of the self-calibration, the output parameters may be robust over process and supply voltage variations.

Calibration may be performed initially on a first transceiver to establish a baseline for calibrating subsequent transceivers. The first transceiver may be referred to herein as a reference transceiver. Furthermore, the transmitter of the reference transceiver may be referred to herein as a reference transmitter and the receiver of the reference transceiver may be referred to herein as a reference receiver. For example, a bit error rate (BER) of the reference transceiver and/or sensitivity of the reference transmitter or reference receiver (e.g., a lowest level of power that can be detected by an antenna) may be determined when calibrating the reference transceiver. The BER and/or sensitivity may vary based on a variety of system parameters. For example, FIG. 2D illustrates an example of bit error rate versus input power and data rate. The lower the input power (e.g., the larger the absolute value or to the left of the plot), the higher the sensitivity may be. The input parameters of subsequent transceivers may be adjusted such that the subsequent transceivers match or attempt to match the BER and/or sensitivity of the reference transceiver within a certain threshold.

Generally, manufacturers of transceivers provide specifications that list an expected gain of the transceiver. Manufacturers typically may not be able to grade their transceivers based on the BER because the transceivers are built using discrete components, especially those transceivers designed for high frequency applications. In contrast, embodiments of the transceivers described herein, such as the MMW transceiver 100, are integrated onto a single chip. Thus, it may be possible to grade the transceivers described herein using the BER because the transceivers can be calibrated to achieve a certain BER (e.g., using the calibration procedures described below). While the gain of a transceiver may be useful to measure, the gain of a transceiver may not provide an indication of the level of performance of the transceiver because the BER and/or sensitivity of the link between a transmitter and receiver may vary given the same gain. Thus, an ability to grade transceivers according to their BER and/or sensitivity is desirable.

FIG. 3 illustrates a flow chart of an example calibration procedure 300 for a reference transceiver package. In an embodiment, the calibration procedure 300 is performed by a testing device and is for a package assembly that includes a reference transceiver (e.g., the transceiver 204) and does not include the reflector 240. In the calibration procedure 300, on-chip substrate coupling and self-coupling of the antenna may be utilized between the transmitter and the receiver of the reference transceiver. Depending on the embodiment, the calibration procedure 300 may include fewer and/or additional blocks and the blocks may be performed in an order different than illustrated.

In block 302, the testing device (e.g., the testing device 250, the testing devices 270A and/or 270B, etc.) may contain a processor that sends a control sequence (e.g., serial, digital control signals) to the transceiver 204. The control sequence may instructions for setting parameters of the transmitter of the transceiver 204. For example, the control sequence may include instructions for setting the output power of the transmitter.

In block 304, the testing device sends another control sequence to the transceiver 204. The control sequence may include instructions for setting parameters of the receiver of the transceiver 204. For example, the control sequence may include instructions for setting the gain of the receiver. The transceiver 204 may transmit a signal once the transmitter and receiver parameters have been set. The signal may be transmitted at the output power designated by the first control sequence. The transceiver 204 may apply a gain to a received signal (e.g., a reflected version of the transmitted signal) based on the gain designated by the second control sequence.

In block 306, the processor may receive a control sequence (e.g., serial data) from the transceiver 204. The control sequence may be received before, during, and/or after the transceiver 204 transmits a signal, receives the reflected signal, and processes the reflected signal. The control sequence may include output parameters generated by the transceiver 204. These output parameters may represent values present during nominal performance (e.g., under normal conditions).

In an embodiment, once the initial set of output parameters has been received, the processor sends one or more control sequences to adjust one or more of the input parameters. A control sequence may include an adjustment of one input parameter or more than one input parameter. After each adjustment, the transmitter may transmit a signal that is received by the receiver, as described above. Based on the transmission, the processor may receive a control sequence that includes updated or revised output parameters. For example, the processor may send one or more control sequences to the transceiver 204 to adjust supply voltage, voltage biases, and/or the like. The processor may then receive a control sequence that includes data on how the output parameters change as the input parameters are varied. The adjusted input parameters may model environmental changes (e.g., changes in temperature). Thus, by varying the input parameters, the processor can receive information on how the transceiver 204 reacts as environmental conditions change.

In some embodiments, an assumption of the calibration procedure 300 is that the coupling factor between the transmitter and the receiver may be in the appropriate range for a MMW system link. For example, for a 60 GHz transceiver chipset in the setup illustrated in FIG. 2B, the coupling factor may be around 50 dB. In block 308, the coupling factor between the transmitter and the receiver of the transceiver 204 is determined. The coupling factor may be determined by the processor. A coupling factor may be determined for each set of output parameters (e.g., the initial output parameters and/or the revised sets of output parameters generated as the input parameters are varied).

In block 310, a bit error rate (BER) of the transceiver 204 is determined. The BER may be determined by the processor. The BER may be dependent on the one or more coupling factors determined based on the output parameters.

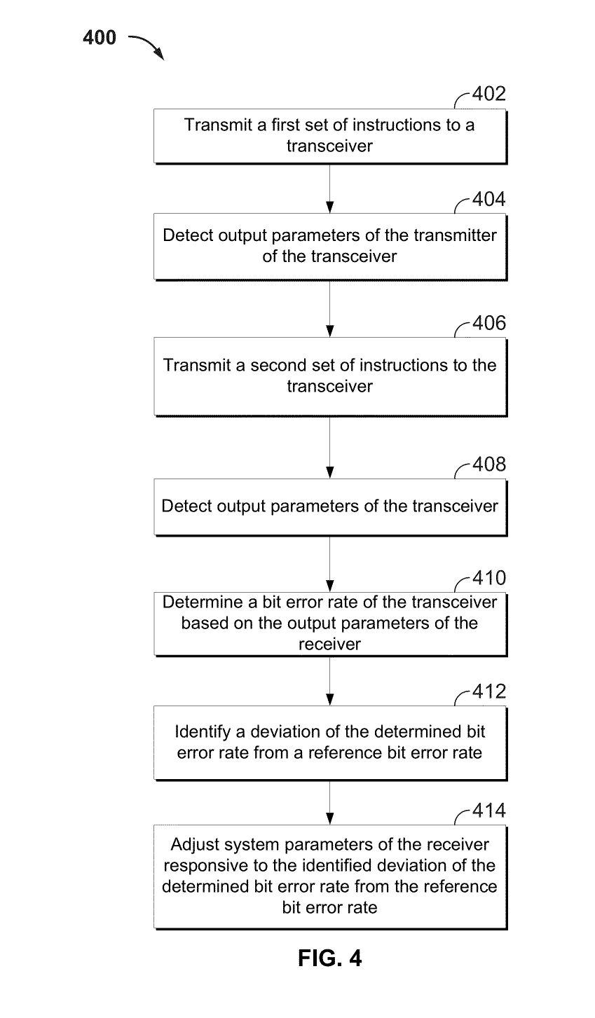

In block 312, a second wireless data transceiver is calibrated based on the determined BER. For example, the determined BER may be a reference or baseline BER. A second wireless data transceiver may be tested and calibrated as described below with respect to FIG. 4. Once the BER for the second wireless data transceiver has been determined, the BER is compared to the reference BER. If the BER for the second wireless data transceiver deviates from the reference BER beyond a threshold value, then the input parameters of the second wireless data transceiver may be adjusted until the BER is within the threshold value of the reference BER.

As described above, in an embodiment, one or more transceiver package self-calibrations can be performed using the BER determined in the calibration procedure 300 and bidirectional control capabilities.

FIG. 4 illustrates a flowchart of a method 400 for self-calibrating a transceiver package. In an embodiment, the method 400 is performed by a testing device (e.g., the testing device 250, the testing devices 270A and/or 270B, etc.). Depending on the embodiment, the method 400 may include fewer and/or additional blocks and the blocks may be performed in an order different than illustrated.

In block 402, a first set of instructions are transmitted to a wireless data transceiver, such as the transceiver 204. The first set of instructions may include instructions for setting input parameters of the transmitter of the transceiver 204. For example, the input parameters may include bias voltages or the transmitter gain. The input parameters may affect a center frequency of a transmitter IF amplifier, a transmitter frequency synthesizer PLL locked voltage, and/or the like. In an embodiment, the first set of instructions is transmitted when the transmitter is on and the receiver is off. In another embodiment, the first set of instructions instructs the transmitter to turn on or stay on and the receiver to turn off or stay off.

In block 404, output parameters of the transmitter are detected after the transmitter transmits a first signal. The first signal may be transmitted by the transmitter in response to receiving the first set of instructions. The output parameters may indicate a performance of the transmitter before, during, and/or after the first signal is transmitted. For example, the output parameters may indicate whether the set input parameters produced a desired result (e.g., a desired transmitter IF center frequency, a desired transmitter frequency synthesizer PLL locked voltage, etc.). Various components of the transmitter may be used to determine the output parameters, such as the transmitter IF power detector.

In an embodiment, the testing device may transmit one or more additional instructions to adjust the input parameters (e.g., to model changing environmental conditions, changing supply voltages, etc.). The instructions may further include commands to turn on the transmitter or the receiver if not already enabled. The transceiver 204 may transmit one or more signals in response to receiving the one or more additional instructions. The testing device may then receive additional output parameters that indicate how the transceiver performs over the varying environmental conditions. For example, the testing device may receive output parameters, such as the RSSI, a receiver BB power level, or a transmitter temperature, that indicate how the transmitter power amplifier performs as environmental conditions change (e.g., the output power of the transmitter power amplifier). The testing device may receive such output parameters when the transmitter and the receiver are both enabled.

If the output parameters indicate that the transmitter did not perform as expected, the testing device may transmit additional instructions to adjust the input parameters until the output parameters indicate that the transmitter is performing as expected. In some embodiments, the testing device may learn as additional wireless data transceivers are calibrated. For example, once the testing device determines the input parameters that generate desired output parameters, the testing device may use those input parameters in the initial set of instructions transmitted to the other wireless data transceivers that are calibrated.

In block 406, a second set of instructions are transmitted to the wireless data transceiver. The second set of instructions may be transmitted based on the detected output parameters. The second set of instructions may include instructions for adjusting the input parameters (e.g., bias voltages) of the transmitter to, for example, model changing environmental conditions. The transmitter may transmit additional signals for some or each of the adjusted input parameters. In an embodiment, the second set of instructions is transmitted when the transmitter is on and the receiver is on. In another embodiment, the second set of instructions instructs the transmitter to turn on or stay on and the receiver to turn on or stay on.

In block 408, output parameters of the transceiver are detected after the transmitter transmits a second signal. The transmitter IF QVCO and/or the receiver IF QVCO may have a known frequency offset, which may be the same or similar to the receiver BB frequency. In some embodiments, an AGC of the receiver is disabled as the receiver produces the output parameters. Various components of the receiver, such as the receiver BB power detector or the receiver IF power detector, may be used to determine the output parameters. For example, the receiver BB power detector may be used to determine the transmitter IF amplifier bandwidth, the receiver IF bandwidth, and/or the receive BB amplifier bandwidth. In some embodiments, the receiver BB power detector may be used to determine the transmitter IF amplifier bandwidth, the receiver IF bandwidth, and then the receive BB amplifier bandwidth in such an order.

The second signal may be transmitted by the transmitter in response to receiving the second set of instructions. The second signal may reflect, for example, off a reflector and be received by the receiver. The receiver may the process the second signal. In some embodiments, the transmitter transmits additional signals, where each signal is transmitted after one or more input parameters are adjusted. In an embodiment, an on-chip BB PLL with a proper division may be used as a source for continuous wave mode data provided to the transmitter input. The continuous wave mode data may represent a random or pseudo random pattern of data that is transmitted by the transmitter for the purpose of calibrating the transceiver. Output parameters may be detected each time the receiver receives a signal transmitted by the transmitter.

In block 410, a BER of the wireless data transceiver is determined based on the output parameters of the receiver. For example, the BER may be based on the output parameters generated in response to the second signal and/or additional signals transmitted by the transmitter. In an embodiment, the BER is determined when the receiver AGC is disabled and a transmitter sequence generator is enabled. The BER may be determined in a receiver sequence checker at different transmitter output power settings and/or different receiver gain settings. The BER may be used to determine an improved or optimum receiver AGC setting and/or to grade the transceiver package. Yield can be determined based on the BER of a plurality of transceiver packages (e.g., the transceivers embedded in a die).

In block 412, a deviation of the determined BER from a reference BER is identified. The reference BER may be determined when calibrating a transceiver in the past using, for example, a calibration method as described above with respect to FIG. 3. The transceiver that produces the reference BER may be a transceiver that will be used for the same or nearly same application as the wireless data transceiver currently being calibrated.

In block 414, input parameters of the receiver are adjusted responsive to the identified deviation of the determined BER from the reference BER (e.g., if the deviation exceeds a threshold value). The input parameters may be adjusted, and the output parameters of the receiver analyzed, until the determined BER is within the threshold value of the reference BER.

As an example, the estimated power loss between the reference transmitter (e.g., with output power set at approximately 8 dBm) and the reference receiver (e.g., about a −57 dBm sensitivity for 1.728 Gbps at 10⁻⁵ BER) may be about 65 dB. The dynamic range of the reference transmitter and the reference receiver (e.g., approximately 60 dB for the used transceiver chipset) can be utilized to determine the performance of a transceiver while the transceiver is being tested. For example, if the transceiver is in the same category as the reference transceiver (e.g., the transceiver has the same or nearly same nominal performance as the reference transceiver, the transceiver is designed for the same or nearly same applications as the reference transceiver), the transceiver may achieve a given BER at a given gain level (e.g., a 15 dB lower gain setting). If the transceiver achieves the same given BER at a lower gain level (e.g., a 20 dB lower gain setting), then the transceiver being tested can achieve about a 5 dB better link than the reference transceiver, and so on. The calibration procedure 300 for determining a coupling factor may be done once for each package type (e.g., manually).

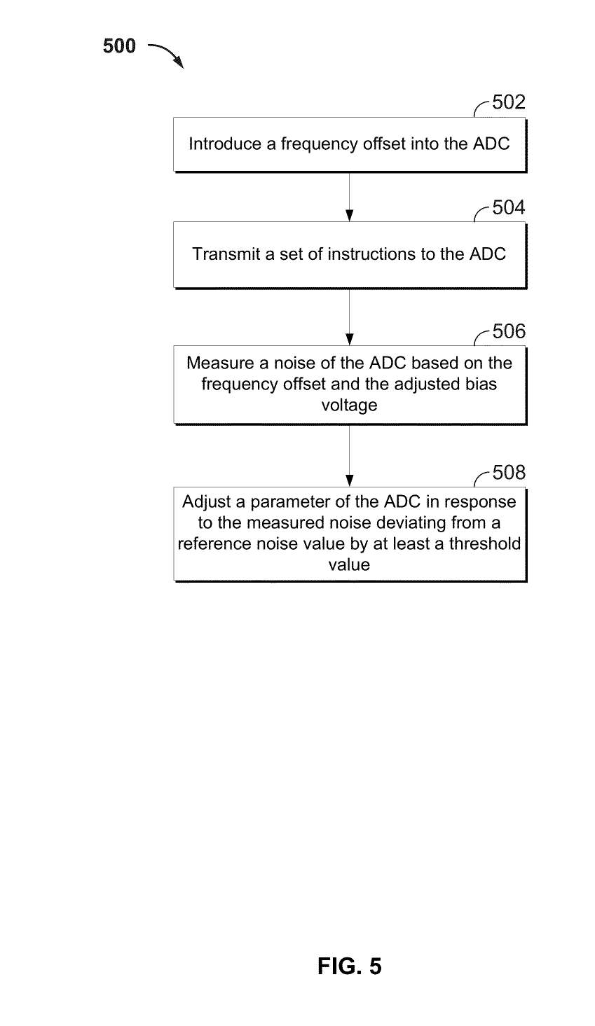

In some embodiments, after a transceiver is calibrated such that it achieves a certain BER, the transceiver may still experience signal distortion or other noise. Such signal distortion or noise may be reduced via the calibration of individual components of the transceiver. For example, an ADC in the receiver chain can be calibrated to reduce signal distortion or noise, as described below with respect to FIG. 5.

FIG. 5 illustrates a flowchart of a method 500 for self-calibrating an ADC in the receiver chain. In an embodiment, the method 500 is performed by a testing device (e.g., the testing device 250, the testing devices 270A and/or 270B, etc.). Depending on the embodiment, the method 500 may include fewer and/or additional blocks and the blocks may be performed in an order different than illustrated.

In an embodiment, before the method 500 begins, parameters of the ADC are optimized. For example, an INL of the ADC and/or a DNL of the ADC are adjusted or optimized using a DC only iterative loop. The DC only iterative loop may include the transmitter being turned off and the receiver MMW and IF front-end circuits being turned off. ADC inputs may be set by a high-resolution digital to analog converter (DAC) in order to adjust or optimize the INL and the DNL.

In block 502, a frequency offset is introduced into the ADC. The frequency offset may be introduced between the transmitter IF QVCO and the receiver IF QVCO. In an embodiment, a BB signal that passes through the ADC may be expected to have a certain frequency. In addition to adjusting the frequency using the frequency offset, the amplitude of the BB signal can be varied using the transmitter gain and/or the receiver gain (e.g., assuming the receiver AGC is disabled).

In block 504, a set of instructions are transmitted to the ADC. In an embodiment, the set of instructions comprise instructions for adjusting a bias voltage of the ADC.

In block 506, a noise of the ADC is measured based on the provided frequency offset and the adjusted bias voltage. In an embodiment, the noise is additionally measured based on the amplitude of the BB signal. The noise may include a signal-to-noise and distortion ratio (SNDR) and/or a spurious free dynamic range (SFDR). The noise may be evaluated using a fast Fourier transform (FFT) block. In an embodiment, the FFT block is part of the digital demodulator in the receiver.

In block 508, a parameter of the ADC is adjusted in response to the measured noise deviating from a reference noise value by at least a threshold value. The parameter may be the INL of the ADC, the DNL of the ADC, a bias voltage of the ADC, and/or the like. For example, a bias voltage (the same bias voltage as above or a different bias voltage) of the ADC may be adjusted, given the frequency offset and a signal amplitude, and the method 500 may be repeated. Method 500 may be repeated until the bias voltages or other parameters of the ADC yield a target noise level. Thus, the SNDR and/or the SFDR may be improved by changing the ADC parameters through iterative digital loops.

### Example Use Case

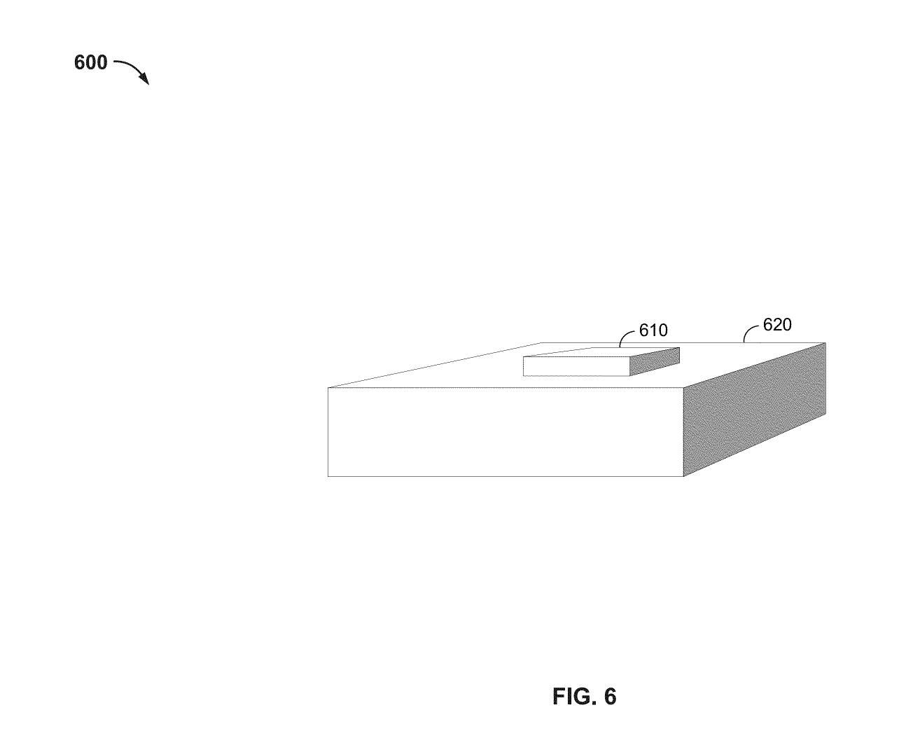

FIG. 6 illustrates an example docking system 600. As illustrated in FIG. 6, the docking system 600 can include an electronic device 610 (e.g., a mobile phone, a tablet, a laptop, etc.) and a docking station 620 (e.g., a television, a desktop computer, a tablet, a device that connects to another peripheral device like a television or a desktop computer, etc.). In an embodiment, the electronic device 610 and the docking station 620 each include a MMW transceiver, such as the MMW transceiver 100 described above. The MMW transceiver included in the electronic device 610 and the docking station 620 may include the features described herein. The electronic device 610 and the docking station 620 can communicate via wireless data transmissions using the MMW transceiver. For example, the electronic device 610 can transmit data (e.g., RAW image files, video files, control signals, etc.) to the docking station 620 using the MMW transceiver. Likewise, the docking station 620 can transmit data (e.g., RAW image files, video files, control signals, etc.) to the electronic device 610 using the MMW transceiver.

In some embodiments, the MMW transceiver is internal to the electronic device 610 and/or the docking station 620. For example, the MMW transceiver could be included with other radios (e.g., GSM, CDMA, Bluetooth, etc.) in the electronic device 610 or docking station 620. In other embodiments, not shown, the MMW transceiver can be connected to the electronic device 610 and/or the docking station 620 via an external connection. For example, the MMW transceiver could be included in a device that connects to the electronic device 610 and/or the docking station 620 via a wired connection (e.g., via USB, Ethernet, IEEE 1394, etc.). Data can then be routed between the electronic device 610 or the docking station 620 and the MMW transceiver via the wired connection.

### Terminology

Although certain types of circuit components are shown and described herein, equivalent or similar circuit components may be used in their place in other embodiments. For instance, example field effect transistors (FETs) shown may be replaced with bipolar junction transistors (BJTs) in some embodiments. Further, NMOS FETs may be replaced with PMOS FETs and vice versa, or NPN BJTs may be replaced with PNP BJTs, and vice versa. Further, many types of FETs can be used interchangeably in the embodiments described herein with slight or no design differences, some examples of which include a CNFET, a DEPFET, a DNAFET, a FREDFET, a HEMT, an IGBT, an ISFET, a JFET, a MESFET, a MOSFET, a MODFET, a NOMFET, an OFET, and the like. Other circuit components shown, including passive components, may likewise be replaced with other electrical equivalents or similar circuits. Furthermore, the values of passive circuit elements, voltages, currents, and power (among other circuit parameters) may be chosen to satisfy any design criterion relevant to the electronic device in which the circuits are implemented.

Although the inventions disclosed herein have been described in the context of certain embodiments and examples, it should be understood that the inventions disclosed herein extend beyond the specifically disclosed embodiments to other alternative embodiments and/or uses of the inventions and certain modifications and equivalents thereof. Further, the disclosure herein of any particular feature, aspect, method, property, characteristic, quality, attribute, element, or the like in connection with an embodiment may be used in all other embodiments set forth herein. Thus, it is intended that the scope of the inventions disclosed herein should not be limited by the particular disclosed embodiments described above. As will be recognized, certain embodiments of the inventions described herein can be embodied within a form that does not provide all of the features and benefits set forth herein, as some features can be used or practiced separately from others.

Many other variations than those described herein will be apparent from this disclosure. For example, depending on the embodiment, certain acts, events, or functions of any of the methods described herein can be performed in a different sequence, can be added, merged, or left out altogether (e.g., not all described acts or events are necessary for the practice of the methods).

Conditional language used herein, such as, among others, “can,” “might,” “may,” “e.g.,” “for example,” “for instance,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A method for calibrating a wireless data transceiver package, comprising:
transmitting, by a testing device, a first control sequence to a wireless data transceiver, wherein the wireless data transceiver comprises a receiver and a transmitter, and wherein the first control sequence comprises instructions for setting input parameters of the transmitter;
transmitting, by the testing device, a second control sequence to the wireless data transceiver, wherein the second control sequence comprises instructions for setting input parameters of the receiver;
receiving, from the wireless data transceiver by the testing device, a third control sequence, wherein the third control sequence comprises a first set of output parameters of the wireless data transceiver;
determining, by the testing device, a first coupling between the receiver and the transmitter based on the first set of output parameters;
determining a bit error rate of the wireless data transceiver based on the determined first coupling; and
calibrating a second wireless data transceiver based on the determined bit error rate.

2. The method of claim 1, further comprising:
transmitting, by the testing device, a fourth control sequence to the wireless data transceiver, wherein the fourth control sequence comprises instructions for adjusting a first input parameter;
receiving, from the wireless data transceiver by the testing device, a fifth control sequence, wherein the fifth control sequence comprises a revised set of output parameters of the wireless data transceiver;
determining, by the testing device, a second coupling between the receiver and the transmitter based on the revised set of output parameters;
determining, by the testing device, the bit error rate of the wireless data transceiver based on the determined first coupling and the determined second coupling; and
calibrating the second wireless data transceiver based on the determined bit error rate.

3. The method of claim 1, wherein receiving a third control sequence comprises receiving the third control sequence after the transmitter transmits a signal based on the first control sequence.

4. The method of claim 1, wherein the first set of output parameters comprises at least one of a transmitter IF center frequency, a transmitter IF power level, a transmitter IF amplifier bandwidth, a receiver IF center frequency, a receiver IF power level, a receiver IF amplifier bandwidth, a receiver BB power level, a receiver BB amplifier bandwidth, a frequency generated by a frequency synthesizer, a frequency synthesizer locked tuning voltage, a transmitter frequency synthesizer PLL locked voltage, a transmitter bandwidth for some or each data rate, a receiver bandwidth for some or each data rate, transmitter temperature, receiver temperature, an automatic gain control (AGC) reference voltage, an analog-to-digital converter (ADC) noise value, an integral non-linearity (INL) of an ADC, a differential non-linearity (DNL) of an ADC, current draw, receiver signal strength indicator (RSSI), a frequency offset of a transmitter IF quadrature voltage-controlled oscillator (QVCO), or a frequency offset of a receiver IF QVCO.

5. The method of claim 1, further comprising:
determining the bit error rate and a sensitivity of the wireless data transceiver based on the determined first coupling; and
calibrating a second wireless data transceiver based on the determined bit error rate and the determined sensitivity.

6. The method of claim 1, wherein the instructions for setting input parameters of the transmitter comprise instructions for setting an output power of the transmitter.

7. The method of claim 1, wherein the instructions for setting input parameters of the receiver comprise instructions for setting a gain of the receiver.

8. A method for self-calibrating a wireless data transceiver package, comprising:
transmitting a first set of instructions to a wireless data transceiver, wherein the wireless data transceiver comprises a receiver and a transmitter, and wherein the first set of instructions comprises instructions for setting input parameters of the transmitter;
detecting output parameters of the transmitter after the transmitter transmits a first signal based on the first set of instructions;
transmitting a second set of instructions to the wireless data transceiver based on the detected output parameters, wherein the second set of instructions comprise instructions for revising the input parameters of the transmitter;
detecting output parameters of the receiver after the transmitter transmits a second signal based on the second set of instructions;
determining a bit error rate of the wireless data transceiver based on the detected output parameters of the receiver;
identifying a deviation of the determined bit error rate from a reference bit error rate; and
adjusting input parameters of the receiver responsive to the identified deviation of the determined bit error rate from the reference bit error rate.

9. The method of claim 8, further comprising:
introducing a frequency offset into an analog-to-digital converter (ADC) of the receiver;
transmitting a third set of instructions to the ADC, wherein the third set of instructions comprises instructions for adjusting a bias voltage of the ADC;
measuring a noise of the ADC based on the provided frequency offset and the adjusted bias voltage; and
adjusting an input parameter of the ADC in response to the measured noise deviating from a reference noise value by at least a threshold value.

10. The method of claim 9, wherein the noise of the ADC comprises at least one of a signal-to-noise and distortion ratio (SNDR) or a spurious free dynamic range (SFDR).

11. The method of claim 8, wherein the input parameters of the receiver comprise at least one of an integral non-linearity (INL) or a differential non-linearity (DNL).

12. The method of claim 8, wherein the instructions for setting input parameters of the transmitter comprise instructions for setting input parameters of the transmitter that affect a frequency of a transmitter intermediate frequency (IF) amplifier center frequency.

13. The method of claim 12, further comprising transmitting a third set of instructions to the wireless data transceiver in response to a determination that the transmitter IF amplifier center frequency deviates from a reference transmitter IF amplifier center frequency by a threshold value, and wherein the third set of instructions comprise instructions for adjusting the input parameters of the transmitter that affect the frequency of the transmitter IF amplifier center frequency.

14. The method of claim 8, wherein the instructions for revising the input parameters of the transmitter comprise instructions for adjusting at least one of a supply voltage and a bias voltage.

15. The method of claim 8, wherein the detected output parameters of the receiver comprise at least one of a receiver intermediate frequency (IF) amplifier center frequency, a receiver IF amplifier bandwidth, or a receiver baseband (BB) amplifier bandwidth.

16. The method of claim 8, wherein adjusting input parameters of the receiver comprises adjusting a gain of the receiver responsive to the identified deviation of the determined bit error rate from the reference bit error rate.

17. The method of claim 8, wherein transmitting a first set of instructions to a wireless data transceiver comprises transmitting the first set of instructions to the wireless data transceiver when the transmitter is enabled and the receiver is disabled.

18. The method of claim 8, wherein transmitting a second set of instructions to the wireless data transceiver comprises transmitting the second set of instructions to the wireless data transceiver when the transmitter is enabled and the receiver is enabled.

19. A wireless data transceiver testing system, comprising:
a reflector configured to redirect wireless transmissions;
a wireless data transceiver package comprising:
a wireless transmitter configured to generate a signal;
a transmit antenna coupled to the wireless transmitter, wherein the transmit antenna is configured to transmit the signal generated by the wireless transmitter;
a receive antenna configured to receive the signal after the signal is redirected by the reflector; and
a wireless receiver configured to process the signal; and
a testing device configured to be coupled to the wireless data transceiver package, the testing device configured to instruct the wireless transmitter to generate the signal, to receive measurements from the wireless data transceiver package after the signal is processed by the receiver, and to use the measurements to calibrate the wireless data transceiver package.

20. The wireless data transceiver testing system of claim 19, wherein the reflector comprises a metal reflecting surface.

21. The wireless data transceiver testing system of claim 19, wherein the testing device is further configured to instruct the wireless transmitter to generate the signal via digital commands.

22. The wireless data transceiver testing system of claim 19, wherein the measurements received from the wireless data transceiver package comprise digital values.

23. The wireless data transceiver testing system of claim 19, wherein the transmit antenna and the receive antenna are coupled through a substrate.

24. The wireless data transceiver testing system of claim 19, wherein the testing device comprises at least one of a probe card or a test socket.
